(19) United States
(12) Patent Application Publication
(10) Pub. No.: US 2006/0031317 A1
(43) Pub. Date: Feb. 9, 2006

(54) System for synthesizing instant message and presence attributes from polled, queried and event information sources

(76) Inventors: Wanrong Lin, Princeton, NJ (US); John Buford, Lawrenceville, NJ (US)

Correspondence Address: HARNESS, DICKEY & PIERCE, P.L.C., P.O. BOX 828, BLOOMFIELD HILLS, MI, 48303, US

(21) Appl. No.: 10/862,166

(22) Filed: Jun. 4, 2004

(51) Int. Cl. G06F 15/16

(52) U.S. Cl. 709/206

(57) ABSTRACT

The system converts polled information sources into event information sources and then intelligently synthesizes new events, based on other polled, queried and subscribed-to notification messages. The newly synthesized events can be used to generate instant messages or for other purposes such as setting presence attributes, controlling devices and performing other actions. An event gateway collects event information and packages and delivers the information in the form of instant messages for other data to mobile and stationary devices according to the user's wishes.

### BACKGROUND OF THE INVENTION

The present invention relates generally to instant messaging and presence. More particularly, the invention relates to a system and method for synthesizing instant messages and presence attributes from multiple information sources. The information sources may be of various types, including polled, queried and event-driven sources. Synthesis of instant messages may be effected using translation, correlation, semantic analysis and other processing techniques.

In its conventional form, instant messaging allows users to exchange short text messages in real time. This form of communication may be distinguished from e-mail, which is a store and forward communication scheme that is perhaps better suited for large messages and attachments. While e-mail may take considerable time to reach the destination, instant messages are transferred in real time and are well suited for interactive communication. Text chat and voice chat have proven to be widely popular forms of instant message communication. Often associated with instant messaging is a service called “presence.” Roughly speaking, presence corresponds to a set of attributes that users of the messaging system can manipulate to advertise their availability for message communication. An exemplary data format for presence might include attributes such as the user's status (online, offline, busy, away, do not disturb) and also any necessary communication address information by which others may initiate a communication session with that user.

### SUMMARY OF THE INVENTION

Conventional instant messaging and presence systems have been traditionally focused on communication among users, simulating in a “chat” format a conversation or dialogue among two or more parties. The present invention departs from the conventional “chat” paradigm. It seeks to synthesize instant messages and presence attributes from multiple information sources. Numerous benefits result:
Information sources that are not directly compatible with instant messaging and presence (IMP) systems can be transparently communicated via gateway into an IMP system.
Multiple information sources can be correlated to produce instant messages with verified content.
Data sources such as webpages can be polled until a specific change is detected. A synthesized instant message of interest is then generated, freeing the user from periodic polling.
Systems can be made more readily configurable. For example, a rules engine may be employed so that translations, filters, and the like, can be modified and extended readily.

According to one aspect of the invention, the system for synthesizing instant messages includes a synthesis module that may be adapted to access a variety of different information sources, including information sources that provide notification messages asynchronously as well as information sources that traditionally must be polled or queried. The synthesis module converts from polled or queried information into synthesized instant messages. These synthesized messages may, in turn, be correlated with information from other sources and a further synthesized message is then generated using semantic analysis to generate a summarized instant message. In addition to generating synthesized instant messages, the synthesis module can also set presence attributes and provide device control instructions that can be used to perform actions as a result of the semantic analysis performed.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention. Accordingly, for a more complete understanding of the invention, its objects and advantages, refer to the remaining specification and to the accompanying drawings.

### BRIEF DESCRIPTION OF THE DRAWINGS

The present invention will become more fully understood from the detailed description and the accompanying drawings, wherein:

FIG. 1 is a block diagram with flow chart illustrating a system for synthesizing information sources to generate instant messages;

FIG. 2 is a block diagram illustrating an exemplary architecture;

FIG. 3 is a process flow diagram useful in understanding the invention;

FIG. 4 is a system block diagram of the event gateway.

### DETAILED DESCRIPTION OF THE PREFERRED EMBODIMENTS

The following description of the preferred embodiment(s) is merely exemplary in nature and is in no way intended to limit the invention, its application, or uses.

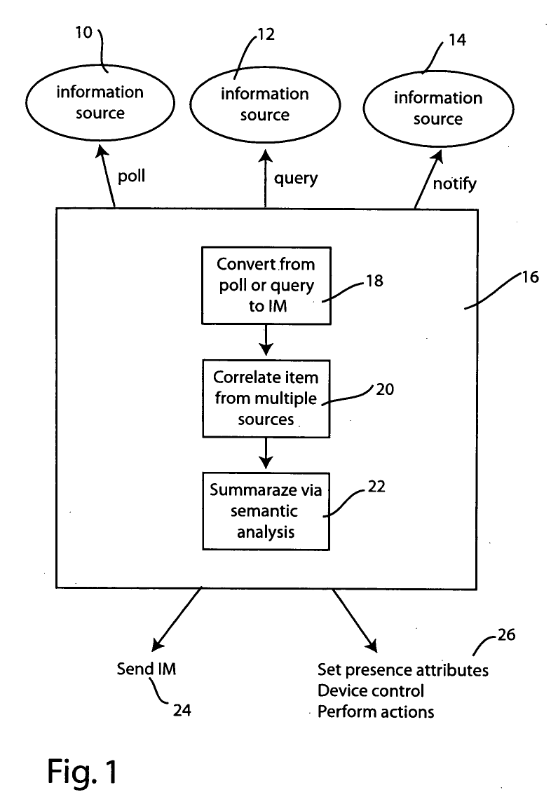

The system for synthesizing instant messages is capable of gathering data from many different types of information sources. Three exemplary sources are illustrated in FIG. 1 at 10, 12 and 14. Information source 10 passively provides information, which the user must poll in order to use the information. Information source 10 cannot respond to specific queries by specific users, nor can it be configured to notify users when pre-specified events have occurred. An example of information source 10 would be a weather report or traffic report broadcast by a conventional AM radio station. The information is provided to the user, perhaps at specific times of the day, but the user must tune into the station at that time and specifically listen to or scan the broadcast information for relevant event information.

Information source 12 is somewhat more sophisticated, in that it is configured to respond to specific queries from users. Information source 12 does not automatically send information to users, but rather it waits until it receives a user's query. An example of information source 12 might be a database containing historic stock price information, or a website containing pages of information accessible through user selection. In the former case, the user query may be represented in a standardized query language, such as SQL. In the latter case, the query can comprise the URL of the requested page of information, optionally including additional parameters to define what the user is requesting.

Information source 14 is different from sources 10 and 12 in that it actively analyzes the information under its control and sends a notification to users when relevant information is located. Users subscribe to information source 14, giving their identity and the specific requirements of the information they are seeking. An example of information source 14 might be a real-time stock price notification system that sends notification messages to subscribed users when the stocks of interest to those users change in price.

As the three types of information sources illustrated in FIG. 1 suggest, there are various events that a user may be interested in, such as a traffic accident on his or her route back home, a schedule change on a favorite sports match, and so forth. Generally there are two modes in which a person can be informed of those events. In the first mode, a person polls the relevant information sources to be aware of those events. Some of those common information sources include television, radio, webpages and newspapers. The polling can take the form of passively receiving, as in the case of radio, or actively seeking, as in the case of webpages. When examined further, even the “passive receiving” is “active seeking” in disguise. Since the person is still actively paying attention to obtain the information he wants. There is a slight difference when compared to the case of webpages. In that case the user has much less control over the raw information pushed to him. We call this “actively seeking” mode “polling mode.” The information source in this mode is referred to as “polled information source.” In the second mode, a person subscribes to a notification service explicitly or implicitly. When an event of the person's interest happens, the service notifies him. We call this “subscribe and wait” mode “eventing mode,” and the notification service is referred to as “event information source.” In information systems, there is also the possibility of querying an information source.

Referring again to FIG. 1, the system for synthesizing instant messages is shown at 16. System 16 obtains information from all three types of information sources and performs a series of processing operations upon the information. As depicted at module or step 18, information received from polled or query sources are converted into instant messages. This entails scanning and syntactically parsing the received information, followed by a subsequent semantic analysis operation or other information processing operation to compare the received information with what the user is interested in.

For example, if information source 10 is a radio broadcast and the user is interested in traffic information that might affect his or her drive home, the system at module or step 18 converts the incoming speech data received from the broadcast into text data using a suitable speech recognizer. The text is then further scanned to look for relevant keywords that would indicate a traffic report in progress. When such relevant keywords are identified, the portion of the text associated by proximity with the keywords is then extracted and compiled into an instant message. In other words, the system at module or step 18 would listen to the AM broadcast on the user's behalf and would then identify relevant segments of the broadcast to be repackaged as instant messages that can be sent to the user.

Note that the user does not even have to use the same form of receiver as the information source is broadcasting. The system 16 of the invention converts the information into an instant message, so that the message can be sent to any instant message-capable device. Thus an alert of a traffic accident, originally broadcast on AM radio, might be sent as an instant message to the user's car navigation system.

While the system at module or step 18 converts polled and queried information sources into instant messages, the messages incoming from information source 14 may not require similar processing. This is because messages from source 14 are already in a notification format. Thus these messages can be readily utilized as instant messages. Of course, in some instances, the formatting of the message may need to be changed to conform to instant messaging standards.

One powerful feature of system 16 is its ability to synthesize new messages based on plural information sources. This capability is provided at module or step 20. At module or step 20 information from multiple sources are correlated. The correlation is performed by tagging incoming messages from source 14 and synthesized instant messages generated by module or process step 18 so that relevant messages pertaining to the same subject matter can be correlated. In one embodiment, the tagging of messages for correlation can simply rely upon keywords found in the instant messages themselves. In a more sophisticated correlation model, messages can be correlated using statistical processing. For example, latent semantic indexing may be performed upon the instant messages to thereby discover which messages have a high probability of being related to the same subject. In some instances, a simple correlation technique may be implemented to correlate messages based on matches in certain fields within the message data structures. Thus for example, messages can be correlated using rules such as, “correlate all messages from John that were initially sent within the last four hours.”

Once a group of messages have been correlated at step 20, system 16 then performs a summarization operation at step 22. The system generates a new, synthesized instant message, based on the content of the correlated messages obtained at step 20. Semantic analysis is preferably used for this purpose.

After the system generates the summarized instant message at step 22, it can then optionally send the summarized message as a new instant message as at 24, or it can perform some other operation. Thus, as illustrated at 26, system 16 can set presence attributes based on the summarized instant message. System 16 can also perform other device control operations and perform other actions, as desired.

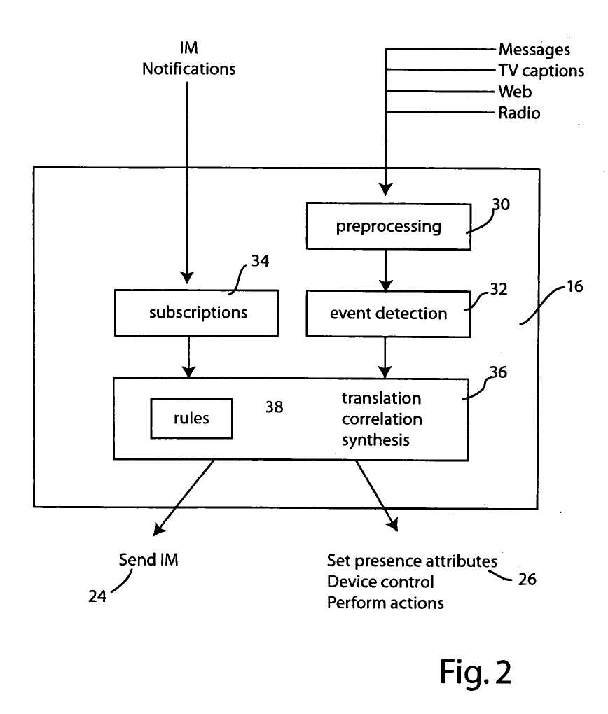

One presently preferred architecture for implementing the instant messaging system 16 has been shown in FIG. 2. To handle messages from polled information sources and query information sources, such as sources 10 and 12 (FIG. 1) a preprocessing module 30 may be employed. It is within the preprocessing module 30 that speech recognition would be performed, for example, to convert a radio broadcast into text. Thereafter, the preprocessed information is sent to an event detection module 32. The event detection module is responsible for comparing the incoming information with a data store of specifications, identifying what types of information the user considers relevant. Thus the event detection module 32 is responsible for converting a stream of polled information into events that can be used to generate instant messages.

The preprocessing module 30 transforms raw information into data that can be conveniently processed by the subsequent components. Some examples of such transformation include:
Audio information (e.g., radio or television audio);
A speech-to-text processor can be applied to transform the audio into plain text. A tuner may also be utilized, if needed.
TV closed captions: A tuner and caption decoder captures and interprets the closed caption text.
Web: A web crawler, an automatic web client and a content extraction module can be applied here to automatically fetch the information from the web and filter out the unrelated components. For example, when activated by the user, an automatic web client can poll the UPS tracking website with the tracking number every few hours and extract the delivery status text from the returned web pages.
Surveillance camera, phone line, motion detector information and the like.

The event detection module 32 analyzes the information provided by the preprocessing module 30. It determines whether a particular event has happened, plus other information relevant to the event. The user can specify rules to be used in this detection. If desired, a natural language parser may be used so the user can specify rules using a natural description and the system transforms that description into rules using an intelligent agent. Examples of such events detection include:
Rain interrupts a tennis match between Agassi and Safin, and the user wants to be notified when the match resumes. The event detection module keeps analyzing the TV closed caption of the sports channel. When it sees the words “Agassi”, “Safin” or “serve” appearing with a certain frequency in the closed caption text, the event detection module makes a judgment that the match has resumed.
The user has ordered something online and wants to be notified one day in advance of the delivery date. The event detection module analyzes the tracking information from the UPS website (preprocessed by the preprocessing module 30) combines it with UPS delivery service working days/hours information and then predicts when the package will be delivered.

The event detection module is preferably capable of working in polling mode. That is, the user or other components in the gateway can inquire of the event detection module for the event status. It is conceivable that for some events only the polling mode may be needed.

Information source 14 (FIG. 1) provides event information automatically, through subscription. Thus system 16 includes a subscription handling module 34, which is responsible for mediating subscriptions to information sources, such as source 14, on the user's behalf and for processing incoming information so that they can be directly utilized as instant messages. The subscription handling module 34 allows a user to subscribe to existing event notification services. The service could be provided through a telecommunication channel like the internet and/or through some other local interface, such as a home network. Based on the service type, push and/or polling mode may be applied.

The outputs of modules 32 and 34 thus both represent event information that the user has expressed an interest in. The event information can be expressed as instant messages, or in some other data structure used internally by system 16.

The event information is then fed to the translation, correlation and synthesis module 36. This module utilizes a set of rules 38 to process the incoming event data and perform the correlation and synthesis (including summarizing) operations discussed in connection with FIG. 1. The output of module 36 can either be in the form of a direct instant message as at 24, or in other forms, as illustrated at 26. It is noted that the outputs at 24 and 26 are the same outputs as were discussed in connection with FIG. 1.

The translation, correlation and synthesis module 36 essentially performs event aggregation and translation services. This entails three main functions:
1. Remove redundancy and reduce false events: to improve the accuracy of event reporting, the user may want to integrate information from multiple sources. For example, the user may want to be notified of breaking news. Since there may be “breaking news” in movies and advertisements, the gateway can analyze events from several TV channels, or combine events from TV, radio and web to determine whether a true event of breaking news has happened. Some of the false event prevention can be performed in the event detection module 32. However, if a false event prevention involves events or information that the event detection module does not see, the translation correlation and synthesis module 36 may perform the false event prevention function.
2. Synthesize high-level events: Some high level events can be logically derived from low-level events. For example, the user wants to be notified of any “unexpected approach to my front and back door while I am not home.” The module 36 analyzes the events from home networks (somebody is approaching the front door, nobody is home), and analyzes the events from the UPS delivery service (today there is no delivery) and determines that this is an unexpected approach. Module 36 may include a separate event synthesis engine for synthesizing high-level events based on low-level events.
3. Translate event information: The event notifications from various service providers may use different protocols and may be in different formats. For easier archiving and subsequent processing of the events, module 36 can translate all of them into a common format, which can be a standardized format or an internal format used by system 16.

As illustrated, system 16 determines what action should be performed upon receipt of an event notification generated by module 36. It can notify the user via a communication means (e.g., mobile phone, short message) specified by the user, or it can control some home device via a home network. Some action decisions may depend on certain patterns of multiple events. Thus the rules 38 may include information used by an action rules engine that detects those patterns of multiple events.

The components illustrated in the architecture of FIG. 2 do not have to be closed. Every component may allow plug-in modules to fit into the overall architecture. A standardized or middleware may be provided to facilitate this. In one presently preferred embodiment, Session Initiation Protocol (SIP) may be adhered to as an event subscription/notification protocol. For example, event subscriptions may subscribe to some event services using SIP protocol, or the event gateway to notify a user via the user's SIP URL.

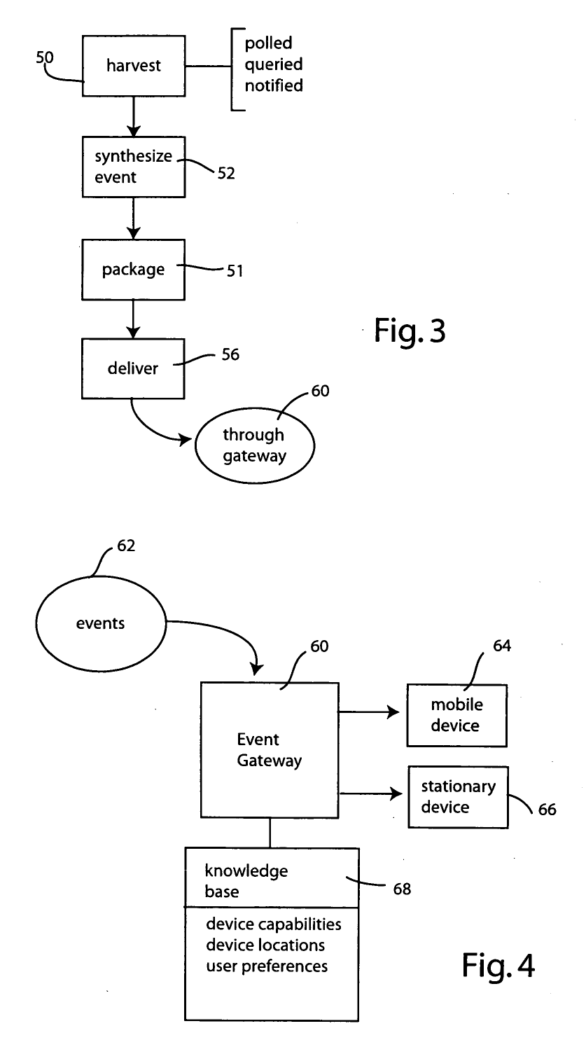

The system for synthesizing instant messages and presence attributes has a variety of uses. Before giving examples of such uses, an understanding of the overall information flow may be helpful. Refer to FIG. 3. As previously discussed, incoming information can be received in polled, queried or notified formats. Information from one or more of such information sources is harvested at step 50 and then used to synthesize an event as at step 52. Once the event is synthesized, a suitable package is constructed to contain the information as at 54. The package may be an instant message, suitable for immediate use by an instant message-ready appliance. The package may be in the form of a command to set presence attributes used in conjunction with an information system, such as an instant messaging system. As discussed previously, the information can also be packaged in a variety of different ways, including device control formats or other action performing instructions to another system.

After the information has been suitably packaged, it is then delivered as at step 56. In a presently preferred embodiment the delivery can be through an event gateway, which is illustrated diagrammatically at 60. The event gateway represents a powerful new system that is made possible, in part, by the system for synthesizing instant messages discussed above.

FIG. 4 illustrates the event gateway in greater detail. The event gateway 60 is configured to learn of events 62 and then deliver relevant information to the user via both mobile devices 64 and stationary devices 66. The event gateway includes a knowledge base 68 that understands the device capabilities of all mobile devices and stationary devices that the user may wish to employ in receiving information from the gateway. The knowledge base also includes information about the device locations. This may include URL information, cellular phone information and physical location information (as obtained by a GPS system). The knowledge base also includes a set of user preferences. This allows the event gateway to be used for multiple people, and even allows multiple people to share the same mobile devices and stationary devices.

Although the system for synthesizing instant messages (system 16 in FIGS. 1 and 2) can be deployed on any suitable platform, one such platform may be the event gateway 60. In other words, event gateway 60 may be programmed to perform the operations described in connection with FIGS. 1 and 2. Thus event gateway 60, itself, can be responsible for harvesting information from plural diverse sources, synthesizing events, packaging and delivering the synthesized messages to the user through a variety of different devices. The event gateway could be made part of a home network or home gateway system. The event gateway would then serve as a user's personal information gathering and information disseminating system. The possibilities are virtually limitless.

For example, by configuring home appliances (e.g., refrigerator, home security system, entertainment system) as information sources, the event gateway could monitor the state of these appliances and provide that information to the user wherever the user happens to be. Thus, driving home from the office the user could use the event gateway system to query the state of the refrigerator, to determine if he or she needs to stop to buy milk on the way home from work. The same event gateway system would also potentially be responsible for monitoring traffic conditions, weather conditions, and a variety of other synthesized events. Regarding synthesized events, these can be constructed from any information sources that the user wishes. Thus the event gateway can serve as a very rich source of information whose outputs may be carefully filtered to provide, in summarized fashion, only the information the user needs at the particular moment.

To further understand some of the capabilities of the present invention, a series of use case scenarios will now be discussed. It will, of course, be understood that these are merely examples of what the system is capable of. There are many other possibilities.

### Use Case Scenario 1: Automatic Polling and Notification

Bob wishes to know when Alice will be offline so that he can call her. He inputs Alice's phone number into the system. The system automatically polls the status of Alice's phone line by dialing Alice's phone number every five minutes to see whether the line is busy. Once the line is free, the system notifies Bob by playing some sound. The rules established to perform this automatic polling and notification function can be configured so that the automatic dialing will hang up as soon as the line free is detected. This will prevent or minimize ringing of Alice's phone and thereby minimize annoyance to Alice.

### Use Case Scenario 2: Automatic Poling and Action-Remote Voice Message

Bob wants to call Alice to tell her something, but she seems to be online eternally. Bob is in a hurry for a meeting and won't be able to call her in the next few hours. As in scenario one, Bob inputs Alice's phone number into the system. In addition, Bob records a voice message for Alice in the system. The system keeps polling the status of Alice's phone line, as in Use Case 1. Once the system detects her phone line is free, the system calls Alice and plays back the recorded voice message (either to Alice or to her phone message recorder).

### Use Case Scenario 3: Automatic Polling and Simple Analysis

Bob ordered something online and wishes to be notified in advance when the package will be delivered by UPS. He inputs the tracking number into the system. The system polls the UPS tracking website with the tracking number every hour. The system calculates the distance between the last package scan location and Bob's home location (probably by polling another webpage like MapQuest). Once the distance is smaller than a certain number, the system sends a notification message to Bob's mobile phone.

### Use Case Scenario 4: Automatic Polling and Complex Analysis

Bob is watching a tennis match between Agassi and Sampras on TV, but rain has interrupted the match. Bob wants to go out and play tennis with his friend but he does not want to miss the match if it is resumed later. He inputs into the system the sentence “Tennis match between Agassi and Sampras resumes from rain interruption” for “event description.” The system keeps monitoring the closed caption data of the TV sports channel using a complex semantic analysis. Once the system detects information in the captions that is semantically equivalent to the event description supplied by Bob, it sends a notification message to Bob, or starts Bob's VCR to record the match.

### Use Case Scenario 5: Event Synthesis Combining Event and Polled Information

Bob is on vacation far from home. He wants to be notified of any unsuspected approach to the front door of his home. Whenever a person approaches his front door, an intelligent surveillance camera generates a notification message through the home network. When the system receives such a notification, it polls the UPS website with the tracking numbers of all packages shipped to Bob (or to Bob's home address) plus a password, if the UPS webpage requires such). The system then checks whether a package is scheduled to be delivered on that day (this would perhaps be represented as “out for delivery” status for the package on the UPS website.) If there is no package being delivered that day, an “unexpected approach” notification message is generated, with picture of the person being sent as part of the message to Bob's mobile phone.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A system for synthesizing instant messages comprising:
a conversion module that converts information extracted from a polled information source into an instant message;
a correlation module coupled to receive instant messages from plural sources, including from said conversion module, and operative to associate said received instant messages based on a predefined critera; and
a message summarization module that operates upon said associated received instant messages to generate a synthesized instant message containing content derived from said assocated received instant messages.

2. The system of claim 1 further comprising polling mechanism operative to obtain information from a polled information source.

3. The system of claim 1 further comprising query mechanism operative to obtain information from a queried information source.

4. The system of claim 1 further comprising subscription mechanism operative to obtain information from a notification information source.

5. The system of claim 1 further comprising output mechanism adapted to send the synthesized instant message.

6. The system of claim 1 further comprising output mechanism adapted to set presence attributes based on said synthesized instant message.

7. The system of claim 1 further comprising output mechanism adapted to control a device based on said synthesized instant message.

8. The system of claim 1 further comprising output mechanism adapted to perform an action based on said synthesized instant message.

9. The system of claim 1 wherein said message summarization module performs semantic analysis upon said associated received instant messages.

10. A system for synthesizing instant messages comprising:
an event detection module receptive of information from a polled information source and operative to identify events based on predefined criteria;
a subscription module adapted to mediate reception of information from a notification information source;
a synthesis module coupled to said event detection module and said subscription module and operative to synthesize instant messages based on information received from said polled information source and from said notification information source.

11. The system of claim 10 wherein said event detection module operates upon text information and wherein said system further comprises a preprocessing module for converting information received from a first information source into a text form usable by said event detection module.

12. The system of claim 11 wherein said preprocessing module performs speech-to-text conversion.

13. The system of claim 11 wherein said preprocessing module extracts closed caption information from a television signal.

14. The system of claim 11 wherein said preprocessing module extracts information from a website and operates to filter out selected portions of the website content.

15. The system of claim 11 wherein said preprocessing module extracts information derived from a camera based on motion detection.

16. The system of claim 10 wherein said event detection module is further operative to interact with queried information sources.

17. The system of claim 10 wherein said event detection module extracts information based on user-defined rules.

18. The system of claim 10 wherein said synthesis module operates to remove redundant information.

19. The system of claim 10 wherein said synthesis module operates to remove false event information.

20. The system of claim 10 wherein said synthesis module synthesizes high-level events by logically deriving them from low-level events.

21. The system of claim 10 wherein said synthesis module synthesizes messages by translating event information.

22. A method of synthesizing instant messages comprising:
harvesting information from plural information sources;
synthesizing an event based on said harvested information;
packaging said synthesized event as an instant message; and
delivering said instant message to an instant message appliance.

23. The method of claim 22 wherein said plural information sources are selected from the group consisting of polled information sources, queried information sources, and notification information sources.

24. The method of claim 22 further comprising delivering said instant message through a gateway configured as an event gateway adapted to handle plural instant messages representing events on behalf of a user.

25. The method of claim 24 wherein said event gateway operates by using a knowledge base that provides information selected from the group consisting of device capabilities, device locations and user preferences.

26. The method of claim 22 further comprising delivering said instant message to a specified instant message appliance by accessing a gateway having stored information used in specifying said instant message appliance.

27. The method of claim 22 wherein said packaging step is performed to conform the instant message to a specified instant message appliance by accessing a gateway having stored information used in determining how the information is packaged for the specified instant message appliance.
